(19) United States
(12) Patent Application Publication
(10) Pub. No.: US 2010/0215175 A1
(43) Pub. Date: Aug. 26, 2010

(54) METHODS AND SYSTEMS FOR STRIPE BLIND ENCRYPTION

(75) Inventors: Robert S. Newson, Windsor (GB); Peter D. Beaman, Newton, MA (US); Tuyen M. Tran, Westwood, MA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Iron Mountain Incorporated

(21) Appl. No.: 12/402,470

(22) Filed: Mar. 11, 2009

Related U.S. Application Data
(63) Continuation-in-part of application No. 12/391,099, filed on Feb. 23, 2009.
(60) Provisional application No. 61/154,618, filed on Feb. 23, 2009.

(51) Int. Cl. G06F 21/00

(52) U.S. Cl. 380/44; 380/28

(57) ABSTRACT

Methods and systems are disclosed that relate to encrypting data of a data item for storing in a data storage system comprising a plurality of disks having stripes. A blinding factor is constructed based on a stripe blind that is assigned to a stripe with which the data item is associated and a unique identifier associated with the data item. A first logic operation is performed between the blinding factor and an encryption key to create a blinded encryption key for the data item. The data item is decrypted by identifying the stripe blind with the unique identifier and recreating the data item's blinding factor based on the stripe blind and the unique identifier. A second logic operation, which is selected based on the first logic operation, is performed between the blinding factor and the blinded encryption key to recreate the encryption key.

### RELATED APPLICATIONS

The present application is a continuation-in-part of U.S. application Ser. No. 12/391,099, entitled “Methods and Systems for Single Instance Storage of Asset Parts,” filed Feb. 23, 2009, and claims the benefit of U.S. provisional application No. 61/154,618, filed Feb. 23, 2009, both of which are hereby incorporated by reference in their entirety.

### BACKGROUND OF THE INVENTION

I. Technical Field

The present invention generally relates to the field of encryption systems and methods and, more particularly, to an archival data storage apparatus for encrypting and managing archival data.

II. Background Information

Computers are connected to storage devices such as disks and disk arrays by network connections such as Ethernet. The data stored on such storage devices is often a proprietary nature. The creation of proprietary information is one of the most valuable intellectual assets developed, shared and traded among individuals, businesses, and institutions. This information is mostly defined in electronic digital formats, e.g., alphanumeric, audio, video, photographic, scanned image, etc. The exposed nature of the storage and transport of this proprietary information, particularly for the purposes of sharing among separate collaboration groups, has significantly increased the risk of interception and theft by criminal elements, competitors, amateur thieves, computer hackers, terrorists, or political or industrial spies.

Especially in the case of networked computer storage, in many cases unauthorized users can gain access to the data stored in such devices. The owner of such data wants to prevent data from being readable or modifiable, and so data storage systems typically employ cryptography to encrypt and decrypt the data stored therein. One cryptographic technique employs a key derivation function (KDF) to derive one or more secret keys from a secret value and/or other known information such as a password or passphrase.

One known technique is the Public Key Encryption (PKE) technique, in which a pair of cryptographic keys (a public key and a private key) are hashed to form a file key that is written to the beginning of a file. The private key is kept secret, while the public key may be widely distributed. The file can only be decrypted with knowledge of the public key and the private key.

Key derivation functions internally often use a cryptographic hash function. Key derivation functions are often used in conjunction with non-secret parameters to derive one or more keys from a common secret value. Such use may prevent an attacker who obtains a derived key from learning useful information about either the input secret value or any of the other derived keys. A KDF may also be used to ensure that derived keys have other desirable properties, such as avoiding “weak keys” in some specific encryption systems.

Key derivation functions are also used in applications to derive keys from secret passwords or passphrases. Such use may be expressed as DK=KDF(Key,Salt,Iterations) where DK is the derived key; KDF is the key derivation function; Key is the original key or password; Salt is a random number which acts as cryptographic salt; and Iterations refers to the number of iterations of a sub-function. The derived key is used instead of the original key or password as the key to the system. The values of the salt and the number of iterations, if not fixed, can be stored with the hashed password or sent as plaintext with an encrypted message.

Some techniques that are known in the art of cryptography as applied to plaintext files include hashing, compressing, and encrypting the plaintext file, hashing the ciphertext, hashing the plaintext hash and the ciphertext hash, and sealing the ciphertext together with the resulting hash.

As the complexity of a password-based key derivation function increases, the likelihood that the data will be secure increases. Modern password-based key derivation functions, such as PBKDF2 (specified in RSA Laboratories' Public-Key Cryptography Standards), use a cryptographic hash, such as MD5 or SHA1, to increase the complexity of the data security system. In addition, they may use more salt (e.g. 64 bits) and/or a large iteration count to increase the security system's effectiveness. There have been proposals to use algorithms that require large amounts of computer memory and other computing resources to make custom hardware attacks more difficult to mount.

In addition, in networked data storage systems, the owner may be concerned with preventing the data from being readable should the disk drives themselves be stolen or lost. To accomplish this, the cryptography system employed with a data storage system may use encryption/decryption techniques such as Key Blinding, in which it is necessary to have possession of key information that is distributed across numerous locations in order to recover the encryption or decryption key. In data storage systems comprising a plurality of disk drives, the key information may be distributed across numerous disk drives. In data storage systems in which data are stored in stripes (or shards), on the plurality of disk drives, the key information may be distributed across numerous stripes. A stripe (or shard) is a grouping of data and/or metadata, formed from one or more logical partitions of data storage. In some data storage systems, the data comprise assets having multiple asset parts, and the metadata associated with the assets and asset parts are stored in stripes, and, again, the key information may be distributed across numerous stripes.

One known encryption/decryption algorithm often used when the key information is distributed across numerous locations is Shamir's Secret Sharing, which is a form of secret sharing. In Shamir's Secret Sharing, a secret is divided into parts. Each participant is given its own unique part and some or all of the parts are needed in order to reconstruct the secret.

Current implementations of cryptographic systems for data storage systems typically use U.S. Department of Defense (“DOD”) 5220 style overwriting (“shredding”) of the encryption key to make forensic recovery of the key (by scanning force microscopy, for example) infeasible. However, given that modern disk drives remap bad sectors to different locations in the disk and given the physics of modern disk drives in general, shredding is potentially inadequate to securely render the key unrecoverable. The DOD no longer accepts data shredding via multiple overwrite paths as an adequate form of data destruction.

There is a need for an encryption method and system to guarantee protection of data in data storage systems, particularly in data storage systems in which assets and asset parts, and the metadata associated with them, are stored in stripes on a plurality of disk drives.

### SUMMARY

The present invention implements methods and systems of protecting data in a data storage system having a plurality of storage devices such as disk drives, in which data of a data item in a plurality of disks of a data storage system are encrypted. The disks have a plurality of stripes and each data item has an independent, unique encryption key with which the data in the data item are encrypted. In one embodiment of the methods and systems, at least one processor is used for constructing a non-zero blinding factor based on a stripe blind and a unique data item identifier associated with the data. The stripe blind comprises a large, securely random value that may be assigned to each stripe in the data storage system. A first logic operation F is then performed between the blinding factor and the encryption key to form a blinded encryption key for the data item identified by the unique data item identifier. The blinded encryption key for the data item may be stored in metadata associated with the item so that it is available later when the data item needs to be decrypted and retrieved.

Using the systems and methods of the invention described herein, the data item is decrypted by the data storage system using information about the data item along with information about the blinding process and the encryption process that was used to encrypt the data item. In one embodiment, a user supplies the unique data item identifier for the target data item to request decryption and retrieval of the data item. The stripe blind and the unique data item identifier value are digested to recreate the blinding factor. A second logic operation G is then performed on the blinding factor and the blinded encryption key to recreate the encryption key. The second logic operation G is selected based on the first logic operation F that was used to form the blinded encryption key, such that:

b=F(u,f) and u=G(b,f); wherein

b is the blinded encryption key,

f is the non-zero blinding factor, and

u is the encryption key.

In one embodiment, the first logic operation comprises an XOR operation of the encryption key and the blinding factor, and the second logic operation is an XOR operation between the blinded encryption key and the blinding factor, that is, F(u,t)=u XOR f and G(b,t)=b XOR f. In other embodiments, the first and second logic operations may be any functions F and G as defined above. When the second logic operation recreates the encryption key, the recreated encryption key may then be used to decrypt the data item.

In another embodiment, a data item may be destroyed by destroying the blinded encryption key associated with the data item. By destroying the blinded encryption key, the encryption key cannot be recreated, and so the target document that was encrypted with the encryption key can no longer be decrypted, resulting in the destruction of the target document.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one (several) embodiment(s) of the invention and together with the description, serve to explain the principles of the invention. In the drawings:

FIG. 1 illustrates an exemplary data storage system consistent with features and principles of the present invention;

FIG. 2 illustrates exemplary storage devices in the data storage system of FIG. 1 configured for redundant storage of assets, consistent with features and principles of the present invention;

FIG. 3 illustrates exemplary data items comprising assets and their corresponding asset parts consistent with features and principles of the present invention;

FIG. 4 illustrates data contained within an exemplary stripe of the storage devices of FIG. 2;

FIG. 5 illustrates an example of a flow diagram of an exemplary procedure for blinding an encryption key for encryption consistent with an embodiment of the invention;

FIG. 6 illustrates an example of a flow diagram of a process for an exemplary procedure for decrypting a document consistent with an embodiment of the invention; and

FIG. 7 illustrates an exemplary procedure for destroying a data item by destroying the blinded encryption key associated with the data item.

### DETAILED DESCRIPTION

In the following description, for purposes of explanation and not limitation, specific techniques and embodiments are set forth, such as particular sequences of steps, interfaces and configurations, in order to provide a thorough understanding of the techniques presented herein. While the techniques and embodiments will primarily be described in context with the accompanying drawings, those skilled in the art will further appreciate that the techniques and embodiments may also be practiced in other network types.

Reference will now be made in detail to present embodiments of the invention, examples of which are illustrated in the accompanying drawings. Wherever possible, the same reference numbers will be used throughout the drawings to refer to the same or like parts. While several exemplary embodiments are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

Within the concept of this specification, a “data storage system” broadly refers to any data storage devices or memories such as hard disk drives, databases, or enterprise storage systems. A data storage system further includes any processors, programs, and applications accessing and/or managing the data storage devices or memories as well as communication links between the data storage devices or memories, and communication links between the processors, programs, and applications and the data storage devices or memories.

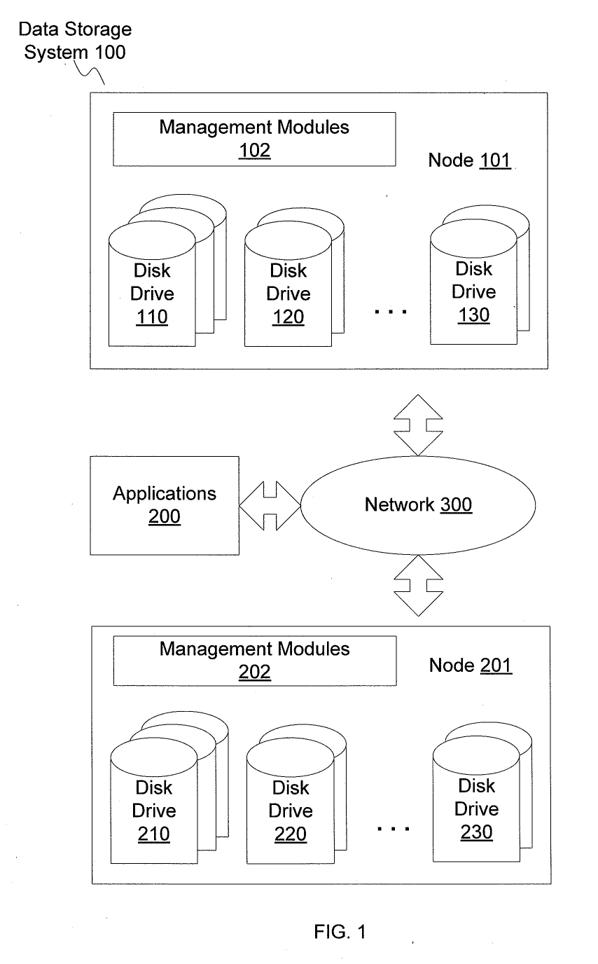

FIG. 1 shows a data storage system 100 having a node 101 and a node 201. As used herein, a “node” refers to a subset of a data storage system having at least one associated disk drive. An example of a node is a server having one or more hard disk drives for storing data. The nodes in a data storage system may be in different geographical locations.

FIG. 1 also shows that data storage system 100 has disk drives 110, 120, and 130 associated with node 101 and disk drives 210, 220 and 230 associated with node 201. As used herein, a “disk drive” refers to any persistent memory accessible by a node, such as an internal or external hard drive. A disk drive may be a RAID drive made up of one or more physical storage devices.

The nodes of data storage system 100 have management modules which include one or more processors, memory, and hardware, software, or firmware used to store and execute instructions to manage the data stored on the disk drives of that node.

For example, management modules 102 and 202 implement algorithms for managing the data stored in disk drives 110, 120, 130, 210, 220, 230. The methods disclosed herein may be implemented by one or more of the management modules 102, 202, and additional management modules not depicted for simplicity. In alternative embodiments, the methods disclosed herein may be implemented by management modules external to the nodes, or by a combination of management modules internal to the nodes, such as management modules 102 and 202, and management modules external to the nodes communicating with the nodes via network 300. Further, in alternative embodiments, memory used by the management modules and instructions implemented by the management modules may be stored in a location on the data storage system external to the management modules themselves.

One of the management modules comprises the cryptographic module that has instructions for assigning a securely generated random number for each disk stripe containing data. This number is called the stripe blind. A stripe blind can be a number of bytes defined according to proper cryptographic practice extant at the time of an embodiment. In one embodiment of the present application, the stripe blind is 32 bytes.

As a security measure, in the illustrative embodiment, the stripe blind itself is not written to any disk, nor is it committed to any form of persistent storage. Instead the stripe blind is a “secret value constructed and maintained only in the volatile RAM memory of the management modules 102 and 202 of the nodes 101 and 201. Data storage system 100 uses a technique such as the well-known Shamir Secret Sharing algorithm to generate and write a number of “shares” on different disks mounted on different nodes. Knowledge of a sufficiently large subset of all shares provides the ability to correctly reconstruct the blind; having fewer shares than the required subset reveals nothing about the blind. Each system has a threshold value that determines the minimum number of shares that would be required for recovering the stripe blind. For example, if the stripe blind is shared across 10 different disks, the threshold can be set to 3 disks. Therefore, the shares from a combination of 3 disks out of 10 would be required. An attacker intending to gain unauthorized access to data by acquiring disk drives removed the data storage system 100 would be require a minimum of at least three drives, greatly increasing the difficulty of a successful attack.

For simplicity, only three disk drives are shown in nodes 101 and 201 of data storage system 100. Although only a few nodes and disk drives are shown throughout the figures for simplicity, embodiments of the present invention can have any number of nodes and any number of disk drives.

Network 300 shown in FIG. 1 provides communications between various entities in data storage system 100, such as node 101, node 201, and applications 200. Network 300 may be a shared, public, or private network, may encompass a wide area or local area, and may be implemented through any suitable combination of wired and/or wireless communication networks. Furthermore, network 300 may comprise an intranet or the Internet. Applications 200 are any programs communicating with nodes 101 and 201, such as those retrieving data from the disk drives at the nodes. An exemplary application is a search engine, whereby a user can search for particular data stored in the data storage system 100.

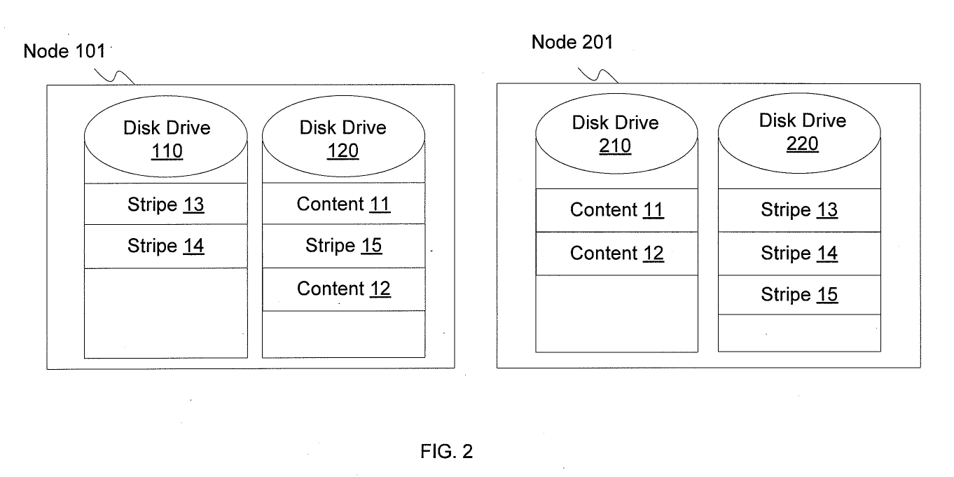

FIG. 2 shows nodes 101 and 201 in more detail according to an embodiment of the present invention. Each disk drive may contain a combination of stripes (also called shards) and content. For example, disk drive 120 contains content 11, content 12, and stripe 15. In alternative embodiments, each disk drive may be permitted to contain only content or only stripes. For example, node 201 has two disk drives 210 and 220, and disk drive 210 contains only content (content 11 and content 12) while disk drive 220 contains only stripes (stripes 13, 14, and 15). In other embodiments, all disk drives on a node may contain only content or only stripes. Moreover, a stripe is a logical entity and replicas of one stripe can be stored on multiple disks. As mentioned above, each stripe has a stripe blind which is a large, securely randomly generated value. The stripe blind is assigned to the stripe, not the disk it is stored on. The blind value for a stripe is the same in each replica and remains the same even as copies of a stripe are moved from one node to another in failure recovery scenarios. There is no correlation between stripe blinds across the disks. To make the stripe blind persistent, as described above, shares are stored to multiple disks using the Shamir Secret Sharing algorithm. The disks that the shares are stored on may or may not be the same or related to the disks on which the replicated stripes are stored.

Each data item, also known as a document, may comprise an asset or, since assets may be made up of asset parts, an asset part. Some asset parts may be unique and other asset parts may be non-unique. The non-unique asset parts contain the same data and metadata as another asset or asset part, and the unique asset parts are the asset parts for which no match is found on the system or which are unique by their nature.

An “asset,” as used herein, refers to one or more units of data. A single asset may correspond to data comprising what an end user application would consider to be a single file, such as a MICROSOFT Office Word™ document, or an email. Assets contain application metadata and one or more asset parts. The application metadata may contain the elements that an application applies in the process of managing the asset, such as annotations or retention data. Asset parts are portions of assets. In an illustrative embodiment, an asset part contains only immutable data, such as an archival copy of a document, but in other embodiments, asset parts may contain changeable data. Typically, the end user application performs the decomposition of an asset into its asset parts.

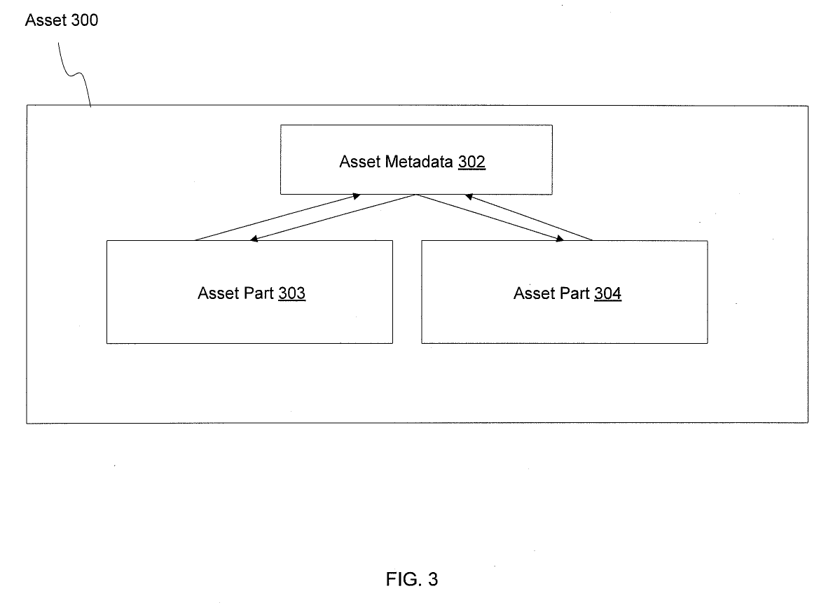

FIG. 3 shows exemplary asset 300. Asset 300 has two asset parts, 303 and 304. If asset 300 is an email, for example, asset part 303 may be the body text of the email and asset part 304 may be an attachment to the email. For another example, if asset 300 is a MICROSOFT Office Word™ document, asset part 303 may be the text and formatting information relating to the text, and asset part 304 may be an embedded figure in the document. In alternative embodiments, an asset may correspond to a portion of a file. Further, in alternative embodiments, more hierarchy may exist so that the asset parts themselves have child asset parts.

In addition to storing asset and asset part content, data storage system 100 stores metadata associated with the assets and asset parts. This metadata is stored in stripes (or shards), which comprise metadata for a group of assets and/or asset parts. A stripe (or shard) is a grouping of data and/or metadata, formed from one or more logical partitions of data storage. The stripe that stores a particular object (data or metadata) should be computed in a deterministic manner, for example, by using an algorithm that chooses a stripe based on a unique identifier associated with the object. In this way, knowing the unique identifier of the object, data storage system 100 can determine which stripe contains the object. FIG. 2 shows exemplary stripes 13, 14, and 15. The data storage system 100 stores replicas of stripes 13, 14, and 15, which are replicated across the plurality of nodes.

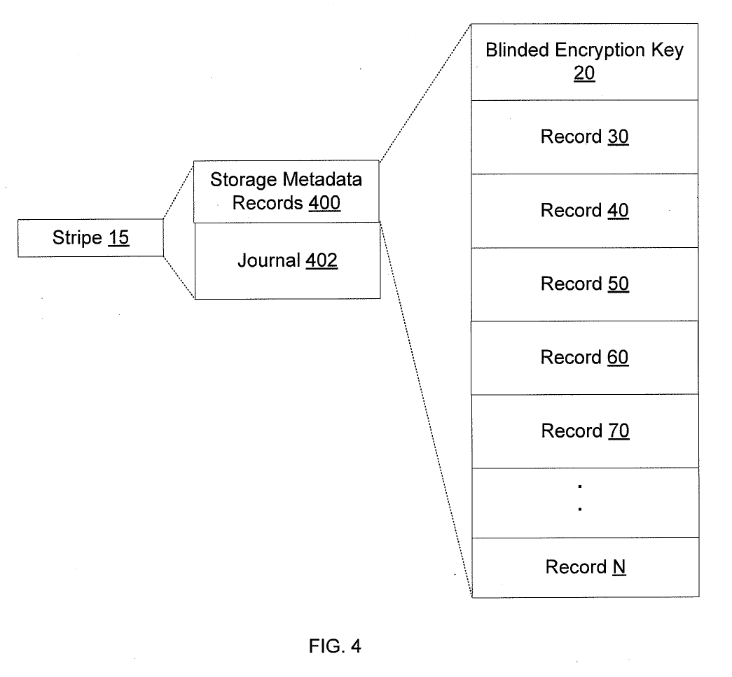

FIG. 4 illustrates exemplary stripe 15 in detail. Stripe 15 contains a storage metadata record for each of the asset parts associated with stripe 15. In an illustrative embodiment, 256 records comprise a page of records, the page comprising storage metadata records 400, but in alternative embodiments any number of records could be associated with a stripe.

In addition, stripe 15 has a journal 402 for maintaining information regarding work to be performed on the assets and/or asset parts associated with the stripe 15. In one illustrative embodiment, all actions to be performed on assets and asset parts associated with the stripe 15 correspond to an entry in the journal 402. Since every action relating to storage metadata records 400 corresponds to an entry in journal 402, in the event of a system failure, the last state of the storage metadata records 400 could be recovered by replaying the journal entries from the start of journal 402. As detailed herein, the data storage system 100 uses journal 402 to maintain the correct reference count for an asset, which is the count of the number of assets that are associated with that asset part.

Every asset and asset part (hereinafter, document or object or data item) is provided with a unique key called an encryption key, which may be used to encrypt and decrypt the data item. In some embodiments, the encryption key may have a fixed length of 32 bytes regardless of the size of the document. The length may vary according to proper cryptographic practice extant at the time of an embodiment. By storing the encryption key in a known location, large numbers of documents can be destroyed quickly by simply destroying their encryption keys at their known locations. Having an independent, unique encryption for each document ensures that, by destroying the key, only the target document is destroyed.

Moreover, every data item is provided with a unique data item identifier which is a value that uniquely identifies the data item. In some embodiments, the data item identifier may comprise the data item's lookup key, with which the data item may be located. In embodiments in which the unique data item identifier comprises the data item's lookup key, the data item identifier maps to the data item in a record in a page (shown in FIG. 4) that holds the storage metadata for the data item. In even further embodiments, the data item identifier may map to content in the sense that the data item identifier may also be the filename that may be used to look up the data item content in the file system. In some embodiments, the data item identifier may map to a virtual location. In other embodiments, the mapping may be directly to the physical location, in which case the data item identifier comprises a file offset for a data item in the file system. The identifier may or may not be secret.

In one embodiment, the unique data identifier value may also be used as the salt input to the KDF. In other embodiments, any unique value that is available without decrypting the asset or asset part may serve as the salt input for the KDF. For example, a randomly generated value may be stored with the asset or asset part on the disk with the metadata associated with the asset or asset part and used as the salt value for the KDF.

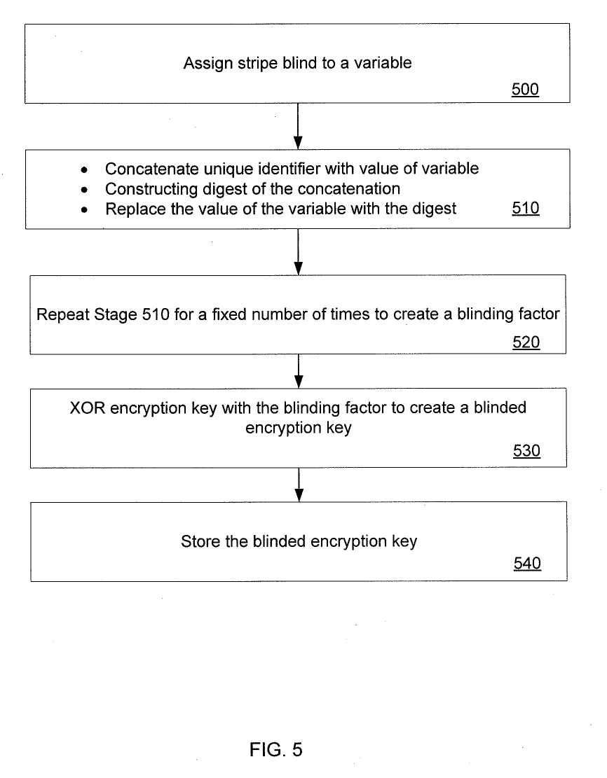

Moreover, for security, the encryption key itself, which a cryptographic module has assigned to a data item and has used for encrypting the data item, is not stored to disk. Instead, the encryption key is blinded and that blinded encryption key is stored to the disk. FIG. 5 illustrates an exemplary procedure for blinding an encryption key. In stages 500, 510 and 520, a blinding factor is constructed by a blinding factor construction module, based on the stripe blind associated with the location of the data item and a unique data item identifier or other suitable salt value described above associated with the data item. In stage 500, the stripe blind is assigned to a variable.

In one embodiment, the blinding factor is the digest (such as an SHA-256 hash) of the concatenation of the salt value assigned to the data item (such as a unique data identifier) and the variable that the stripe blind is assigned to. In stage 510, the unique identifier is concatenated with the value of the variable and then, the value of the variable is replaced with the digest of the concatenation of the value of the variable and the unique identifier. In stage 520, the stage 510 is repeated a selected number of times for additional security. In an illustrative embodiment, the number of times that stage 510 is repeated is large and it may be fixed. In one illustrative embodiment, the stage 510 is performed 256 times. In other embodiments any suitably strong Key Derivation Function that combines the stripe blind and a suitable salt value may be used to generate the blinding factor. Then, in stage 530, a first logic operation is performed between the blinding factor and the encryption key. In the illustrative embodiment shown in FIG. 5, the first logic operation comprises an XOR operation, in which the blinding factor is XOR'd with the 32-byte encryption key. The result of this XOR operation provides the blinded encryption key (shown in FIG. 4 as blinded encryption key 20). In a stage 540, the blinded encryption key is stored in storage metadata records 400 (as shown in FIG. 4).

Using the systems and methods of the invention described herein, the data item or document is decrypted by the data storage system using information about the data item along with information about the encryption process that was used to encrypt the data item and the blinding process that had been used to protect the encryption key used in the encryption process. The actual encryption key used to encode or decode a document is computed from the stored bits maintained in the storage metadata for the document, and the blind values for the stripes on which the contents of the data item are stored. A known technique called Key Derivation is used to encode each encryption key in such a way that even if the true unblinded key value corresponding to one blinded key becomes known, no information about the remaining blinded keys is revealed.

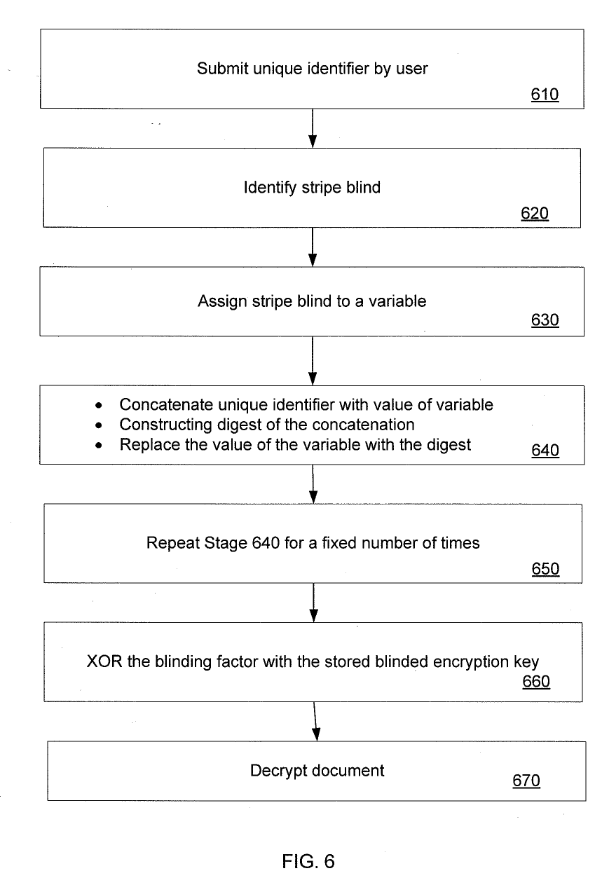

FIG. 6 illustrates an exemplary procedure for decrypting a document. In stage 610, the user submits the unique data item identifier value of the document to the cryptographic module for use in identifying the stripe blind. In stage 620, the stripe blind is identified. In stages 630, 640 and 650, the stripe blind and the unique data item identifier value are used to recreate the blinding factor by a blinding factor recreation module. In stage 630, the stripe blind is assigned to a variable. In one embodiment, the blinding factor is the digest (such as an SHA-256 hash) of the concatenation of the unique data identifier and the variable that the stripe blind is assigned to. In stage 640, the unique identifier is concatenated with the value of the variable and then, the value of the variable is replaced with the digest of the concatenation of the value of the variable and the unique identifier. In stage 650, the stage 640 is repeated a selected number of times for additional security. In an illustrative embodiment, the number of times that stage 640 is repeated is large and it may be fixed. In stage 660, a second logic operation is then performed on the blinding factor and the blinded encryption key to recreate the encryption key. The second logic operation G is selected based on the first logic operation F, such that

b=F(u,f) and u=G(b,t), wherein

b is the blinded encryption key,

f is the non-zero blinding factor; and

u is the unblinded encryption key.

In one embodiment, the second logic operation is the inverse of the first logic operation that was used in forming the blinded encryption key. In the embodiment in which the first logic operation is an XOR operation between the encryption key and the blinding factor, the second logic operation is an XOR operation between the blinded key and the blinding factor. While one exemplary embodiment is described herein, modifications, adaptations and other implementations are possible, without departing from the spirit and scope of the invention, so long as the first and second logic operations comprise a pair of functions such that, using one function, the blinded encryption key b may be combined with the blinding factor f to form the unblinded encryption key u, and, using the other function, the unblinded encryption key u may be combined with the blinding factor f to form the blinded encryption key b. The result of stage 660 gives the original, unblinded encryption key that can now be used decrypt the document in stage 670.

In one embodiment, a data item may be destroyed by destroying the blinded encryption key associated with the data item, which renders it impossible to obtain a copy of the encryption key. By destroying the blinded encryption key, only the target document is destroyed. Without the blinded encryption key, it is impossible to compute the unblinded, true encryption key. The unblinded encryption key, which is what the blinding technology protects, exists only briefly in the node's volatile memory. Without the unblinded encryption key, the data item that was encrypted with the key cannot be decrypted. Therefore, recovering the content of the data item, even if an attacker were able to acquire the encrypted content bytes, is cryptographically infeasible. Therefore, the systems and methods described herein may be used to ensure that no one, whether a malicious entity or a government operating under subpoena, can recover a copy of the blinded encryption key.

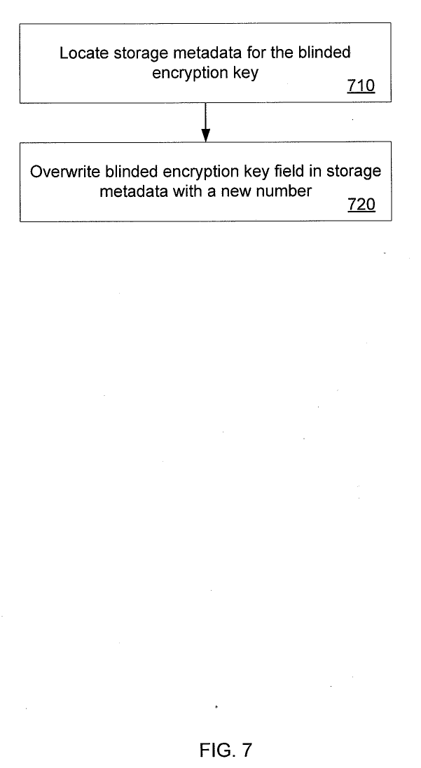

FIG. 7 illustrates an exemplary procedure for destroying the blinded encryption key. In stage 710, the storage metadata and its replicas, where the blinded encryption key is stored, are located using the data item's unique data item identifier. In stage 720, the blinded encryption key field in all replicas of that storage metadata is overwritten, for example by the following values, in sequence: zeros, ones, and then random bits.

In another embodiment of the present application, new blinds are allocated for all stripes periodically, for instance once per week, and the blinded encryption keys are re-blinded with the new blinds. Once this process is done, then a sufficient subset of the shares of the original blinds are physically destroyed to ensure that no recovery of keys blinded by the original blind values is possible, rendering any obsolete keys harmless. The stripe shares in this algorithm may be stored on an alternative medium that can be economically destroyed. For example, one technique would be to burn the shares to a set of CD-ROM disks. These can be removed and stored securely once written, and when destruction is required, these can economically be physically destroyed.

Although the disclosed modules have been described above as being separate modules, one of ordinary skill in the art will recognize that functionalities provided by one or more modules may be combined. As one of ordinary skill in the art will appreciate, one or more of modules may be optional and may be omitted from implementations in certain embodiments.

The foregoing description has been presented for purposes of illustration. It is not exhaustive and does not limit the invention to the precise forms or embodiments disclosed. Modifications and adaptations of the invention will be apparent to those skilled in the art from consideration of the specification and practice of the disclosed embodiments of the invention. For example, the described implementations may be implemented in a software, hardware, or a combination of hardware and software. Examples of hardware include computing or processing systems, such as personal computers, servers, laptops, mainframes, and micro-processors.

What is claimed is:

1. A computer-implemented encryption method for encrypting data of a data item for storing in a data storage system comprising a plurality of disks having a plurality of stripes, the method comprising:
using at least one processor for:
constructing a blinding factor for the data item with a blinding factor construction module, wherein the blinding factor is based on:
a stripe blind that is assigned to a stripe with which the data item is associated, and
a unique identifier associated with the data item; and
performing a first logic operation between the blinding factor and an encryption key associated with the data item to create a blinded encryption key for the data item.

2. The computer-implemented encryption method of claim 1, further comprising performing a decryption method for decrypting the data item, the decryption method comprising:
identifying the stripe blind by using the unique identifier;
recreating the blinding factor for the data item with a blinding factor recreation module, wherein the recreating is based on the stripe blind and the unique identifier; and
performing a second logic operation between the blinding factor and the blinded encryption key to recreate the encryption key, wherein the second logic operation is selected based on the first logic operation.

3. The method of claim 2, wherein the decryption method further comprises decrypting the data item with the recreated encryption key.

4. The computer-implemented encryption method of claim 2, wherein the second logic operation is the inverse of the first logic operation.

5. The computer-implemented encryption method of claim 1, wherein constructing a blinding factor further comprises:
assigning the stripe blind to a variable having a value;
concatenating the unique identifier with the value of the variable;
constructing a digest of the concatenation of the value of the variable and the unique identifier; and
replacing the value of the variable with the digest.

6. The computer-implemented encryption method of claim 5, wherein constructing a blinding factor further comprises repeating the concatenating, constructing a digest and replacing steps for a selected number of times.

7. The computer-implemented encryption method of claim 1, wherein the first logic operation is an XOR operation.

8. The computer-implemented encryption method of claim 2, wherein the first logic operation and the second logic operation are XOR operations.

9. The computer-implemented encryption method of claim 1, further comprising storing the blinded encryption key in metadata associated with the stripe.

10. The computer-implemented encryption method of claim 1, further comprising destroying the data item by destroying the blinded encryption key associated with the data item.

11. The computer-implemented encryption method of claim 1, wherein the stripe blind is driven by a key derivation function from a common secret value.

12. The computer-implemented encryption method of claim 1, wherein the stripe blind is distributed across a set of disks.

13. The computer-implemented encryption method of claim 1, further comprising destroying the data item by destroying the set of disks.

14. A data storage encryption system for encrypting data of a data item for storing in a data storage system comprising a plurality of disks having a plurality of stripes, comprising:
computer executable instructions operative on a cryptographic processor module for:
constructing a blinding factor for the data item with a blinding factor construction module, wherein the blinding factor is based on:
a stripe blind that is assigned to a stripe with which the data item is associated, and
a unique identifier associated with the data item; and
performing a first logic operation between the blinding factor and an encryption key associated with the data item to create a blinded encryption key for the data item.

15. The system of claim 14, further comprising computer executable instructions for decrypting the data item, the decrypting further comprising:
identifying the stripe blind by using the unique identifier;
recreating the blinding factor for the data item with a blinding factor recreation module, wherein the recreating is based on the stripe blind and the unique identifier; and
performing a second logic operation between the blinding factor and the blinded encryption key to recreate the encryption key, wherein the second logic operation is selected based on the first logic operation.

16. The system of claim 14, wherein the stripe blind is a shared value across a set of disks.

17. A computer program product comprising a computer usable medium having a computer readable program code embodied therein, the computer readable program code configured to be executed to implement a method for encrypting data of a data item for storing in a data storage system comprising a plurality of disks having a plurality of stripes, the method comprising:
constructing a blinding factor for the data item with a blinding factor construction module, wherein the blinding factor is based on:
a stripe blind that is assigned to a stripe with which the data item is associated, and
a unique identifier associated with the data item; and
performing a first logic operation between the blinding factor and an encryption key associated with the data item to create a blinded encryption key for the data item.

18. The computer program product of claim 17, wherein the computer readable program code is further configured to be executed to implement a decryption method for decrypting data of the encrypted data item, the decryption method further comprising:
identifying the stripe blind by using the unique identifier;
recreating the blinding factor for the data item with a blinding factor recreation module, wherein the recreating is based on the stripe blind and the unique identifier; and
performing a second logic operation between the blinding factor and the blinded encryption key to recreate the encryption key, wherein the second logic operation is selected based on the first logic operation.

19. An encryption apparatus having at least one cryptographic processor module for:
constructing a blinding factor for the data item with a blinding factor construction module, wherein the blinding factor is based on:
a stripe blind that is assigned to a stripe with which the data item is associated, and
a unique identifier associated with the data item; and
performing a first logic operation between the blinding factor and an encryption key associated with the data item to create a blinded encryption key for the data item.

20. The encryption apparatus of claim 19, further comprising a decryption module for decrypting the data item, the decrypting further comprising:
identifying the stripe blind by using the unique identifier;
recreating the blinding factor for the data item with a blinding factor recreation module, wherein the recreating is based on the stripe blind and the unique identifier; and
performing a second logic operation between the blinding factor and the blinded encryption key to recreate the encryption key, wherein the second logic operation is selected based on the first logic operation.

21. A decryption method of decrypting data of a data item encrypted using an encryption key and stored in a data system comprising a plurality of disks having a plurality of stripes, the encrypted data having a blinded encryption key, and the decryption method comprising:
identifying a stripe blind that is assigned to a stripe with which the encrypted data item is associated by using a unique identifier associated with the encrypted data item;
creating a blinding factor for the encrypted data item with a blinding factor creation module, wherein the blinded factor is created based on the stripe blind and the unique identifier; and
performing a logic operation between the blinding factor and the blinded encryption key to recreate the encryption key, wherein second logic operation is selected based on a blinding logic operation that had been used to create the blinded encryption key.
